(19) United States
(12) Patent Application Publication
(10) Pub. No.: US 2013/0238404 A1
(43) Pub. Date: Sep. 12, 2013

(54) COMPETENCE ASSESSMENT METHOD AND SYSTEM

(71) Applicants: Fernando Alba ELIAS, Logrono (ES); Ana Gonzalez MARCOS, Logrono (ES); Joaquin Ordieres MERE, Madrid (ES)

(72) Inventors: Fernando Alba ELIAS, Logrono (ES); Ana Gonzalez MARCOS, Logrono (ES); Joaquin Ordieres MERE, Madrid (ES)

(21) Appl. No.: 13/739,918

(22) Filed: Jan. 11, 2013

(30) Foreign Application Priority Data
Mar. 12, 2012 (ES) P201200289

(51) Int. Cl. G06Q 10/06

(52) U.S. Cl. CPC G06Q 10/06398
USPC 705/7.42

(57) ABSTRACT

The present invention relates to a method and competence assessment system for assessing the competences of a participant in a project. The method includes assessing at least one competence of at least one participant in a project by applying a mathematical formula. The project includes at least one phase, at least one competence of an assessed participant intervening in at least one phase of the project, the competence being assessed by at least one assessor figure by at least one piece of evidence.

### CROSS REFERENCE TO RELATED APPLICATIONS

The present application is related to and claims priority under 35 U.S.C. §119 to Spanish patent application P201200289, filed in Spain on Mar. 12, 2012, the entire contents being incorporated herein by reference.

### BACKGROUND OF THE INVENTION

1. Field of the Invention

The present invention generally relates to the field of project management and project organization, and it more specifically relates to a competence assessment method for assessing the competences of project managers or directors having influence on a project, as well as project technicians, and an implementation system for implementing said method.

2. Discussion of the Background Art

Project management and organization is currently a relevant field in any social-occupational and industrial environment. Good or bad management of a given project can be fundamental for its satisfactory or unsatisfactory development, which will ultimately dictate obtaining a commercially viable product or not or will facilitate a strategic change or not in an organization.

Competence assessment or management systems are known in the state of the art. For example document US2005159968 relates to a system that allows the acts of workers to be followed and consequently allows a possible assessment of the tasks performed. Document US2005228762 relates to a competence assessment system, where business objectives and market conditions are used for identifying the particular competences and corresponding requirements of the progress, which allows rating the degree of user preparation. Document US2008140485 relates to a system that allows assessing a project throughout its development, where the information is collected throughout the execution of the project and the milestones to be achieved are monitored. Another document, US2010198847, relates to a competence assessment system for assessing competence in project management. The information obtained in the execution of the project is simply compared with the best practices for obtaining a rating of the competences. However none of these documents allows assessing the competences of the user objectively, since the user's assessment and final grade usually depends on a single person. Furthermore, the known systems are usually adapted to a very definite assessment environment, therefore their application is very limited. Finally, none of the known systems allows obtaining a numerical rating of the competences in an automated and objective manner taking into account a multitude of simulation environment parameters.

Despite the enormous importance that this field has for the industry, substantial research efforts are not dedicated to it and there is currently no adequate method or system that allows assessing the organization of a project and foreseeing its viability, therefore allowing preventative corrective measures to be performed if necessary for optimizing its outcome.

An objective of the present invention is to therefore cover a void existing in the prior art providing a competence assessment method and system that facilitates consistently assigning resources for improving project organization and management.

### SUMMARY OF THE INVENTION

In a first aspect, there is a competence assessment method for assessing the competences of participants in a project. The project to which the method can be applied includes at least one phase, at least one competence of an assessed participant intervening in at least one phase of the project, and the competence is assessed by at least one assessor figure by means of at least one piece of evidence. The method includes specifically determining, in a simulation environment, a numerical assessment of the achievement level of each competence depending on given variables:

Cmpᵢ=fᵢ(Ev_{j,s},Wₓ,kᵣ,pⱼ)

More preferably, the above formula fᵢ is the following formula:

$${Cmp}_{i} = \frac{1}{{\sum }_{x = 1}^{l} {W}_{x}} \cdot \frac{1}{{\sum }_{r = 1}^{m} {k}_{r}} \cdot \frac{1}{{\sum }_{j = 1}^{n} {p}_{j}} \cdot {\sum }_{x = 1}^{l} {\sum }_{r = 1}^{m} {\sum }_{j = 1}^{n} {W}_{x} \cdot {k}_{r} \cdot \frac{{p}_{j}}{{q}_{r}} {\sum }_{s = 1}^{{q}_{r}} E {v}_{j , s}$$

wherein
Cmpᵢ is the numerical assessment of the achievement level of the competence i;
Wₓ is the weight of the phase x in which the competence is assessed;
x is the phase in which the competence is assessed;
l is the total number of phases in which the competence is assessed;
kᵣ is the weight of the opinions of each assessor figure;
r is the assessor figure carrying out a specific function;
m is the total number of assessor figures;
pⱼ is the weight of each piece of evidence of a competence;
j is a piece of evidence;
n is the total number of pieces of evidence of a competence;
qᵣ is the total number of assessors with the same function;
Ev_{j,s}, is the numerical assessment of the piece of evidence j obtained from each assessor s with the same function;
s is the assessor with a given function performing the assessment.

Therefore, it is possible to obtain a numerical assessment of the participants of a project in each of the competences they carry out, thus allowing assessing their suitability for carrying out specific functions on the basis of their abilities in specific competences and, depending on the results obtained, improving the organization of the project by assigning the various functions to the participants with the highest score in the competences relevant to these functions.

According to a second aspect of the present invention, there is a competence assessment system for assessing the competences of participants in a project implementing the method according to the first aspect of the invention is provided. is the competence assessment system includes a computer system with a processor configured to operate in accordance with a multilayer architecture, the multilayer architecture including at least three layers:
a presentation layer providing a user interface;
an application layer implementing the functionality of the competence assessment method according to the first aspect of the present invention; and
a data layer providing the management and storage of the data related with the method.

### BRIEF DESCRIPTION OF THE DRAWINGS

The present invention will be better understood with reference to the following drawings which illustrate an embodiment of the invention, provided by way of example, and which must not be interpreted as limiting the invention in any manner.

FIG. 1 schematically shows the hierarchy of a project by way of example in which a method according to an embodiment of the invention can be applied.

FIG. 2 schematically shows the assignment of subprojects, including subcontracted projects depending on the hierarchy shown in FIG. 1.

FIG. 3 shows the assessment interactions of a participant in a subproject by the participants of the project interacting with said participant according to an embodiment of the invention.

FIG. 4 shows a block diagram of software modules associated with an assessment system according to an embodiment of the invention.

FIG. 5 shows a block diagram of hardware modules associated with an assessment system according to an embodiment of the invention.

### DETAILED DESCRIPTION OF THE INVENTION

### Competence Assessment Method

The present invention firstly provides a competence assessment method for assessing the competences of the various participants in a project. A project is understood as being a time and cost limited operation for producing a set of specific deliverables, i.e., meeting the objectives of the project according to quality standards and requirements.

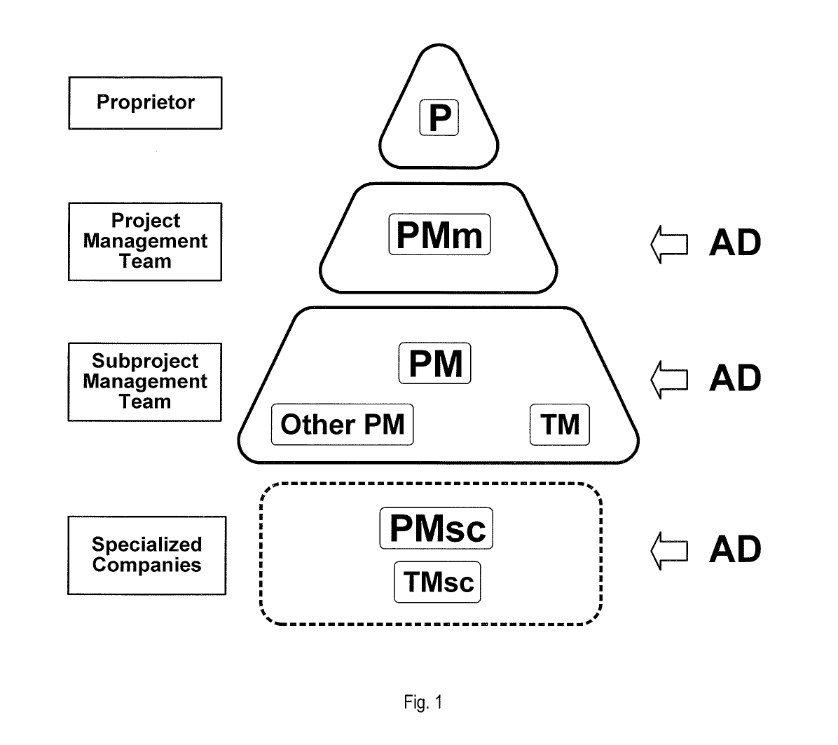

As can be observed in FIG. 1, a project may include:
a proprietor or end client (P, proprietor), who is the owner of the project which is going to be assessed;
a project management team including at least one main manager (PMm, project manager master);
a subproject management team including at least one subproject manager (PM, project manager) and members of a subproject work team (TM, team member);
specialized companies or subcontractors, including subcontractor managers (PMsc, project manager specialized company) and members of a subcontractor work team (TMsc, team member specialized company); and auditors (AD, auditor).

The organizational structure shown in FIG. 1 shows the various functions that can participate in a project. However, a person skilled in the art will easily understand that one and the same person could carry out one or more of the functions shown. For example, the proprietor of the project could be the auditor.

It is thus evident that said structure can also be applied without any modifications at other levels within a more complex structure, such as for example to a structure formed by: program, project and subcontract project or to a structure formed by a project portfolio, project and subcontract project. For the sake of clarification, a program may be understood as being a set of related projects established for attaining a strategic objective, while a portfolio is understood as being a set of projects or programs, not necessarily related to one another, brought together for the purpose of controlling, coordinating and optimizing the portfolio in its entirety.

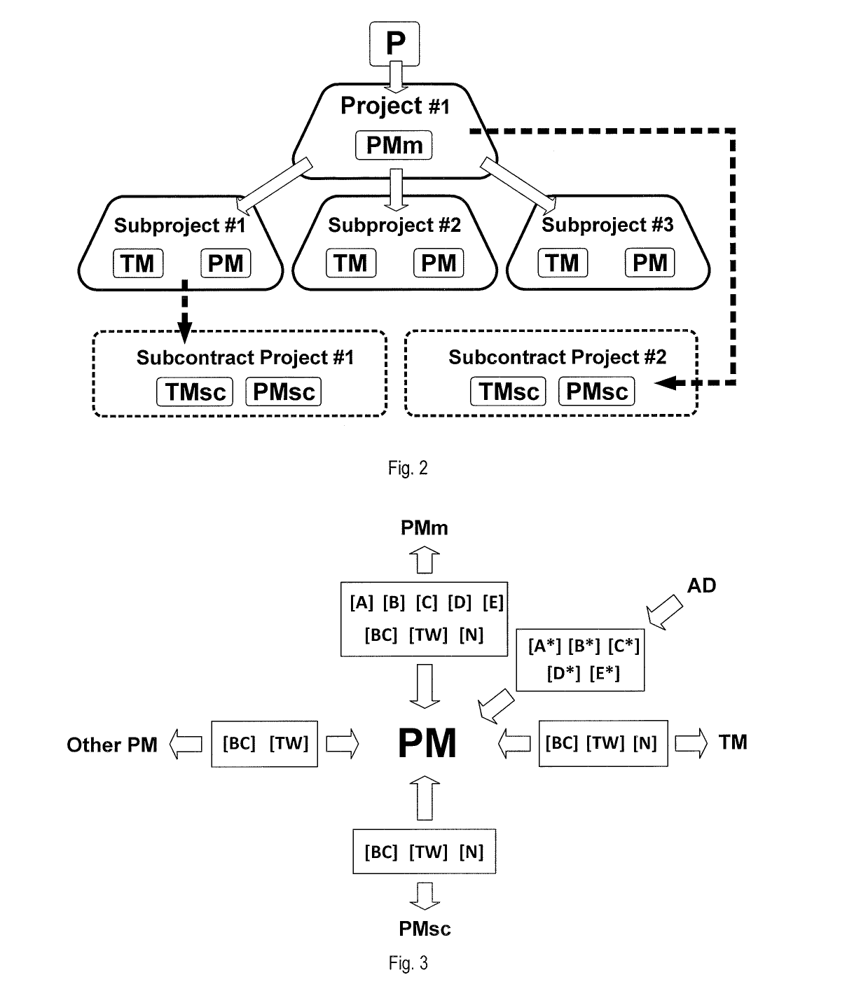

FIG. 2 shows the initial organization of a project according to an embodiment of the invention. The proprietor is the owner of a project commissioned to the project management team. The work of this project is in turn divided into three subprojects, which are assigned to three subproject management teams. In turn, the first subproject management team negotiates the outsourcing of part of the subproject to a first specialized company (subcontract project). On the other hand, however, the project management team negotiates a second subcontract project with a second specialized company.

In turn, each project, subproject or subcontract project is divided into several phases including, for example, the following phases:
a) scope definition phase: phase A₁;
b) project plan approval phase: phase B₁;
c) execution phase: phase C;
d) execution control phase: phase D;
e) closing phase: phase E;
f) scope updating phases, developed in parallel with phases C and D: phases Aₙ; and
g) project plan updating phases, developed in parallel with phases C and D: phases Bₙ.

In each of the above phases, the assessable participants develop specific competences, which are assessed by at least one assessor figure by means of at least one piece of evidence. Said numerical assessments of the various pieces of evidence are performed by means of forms. However, a person skilled in the art will easily understand it is possible to apply the method according to the present invention for assessing a participant participating in one or all of the phases of the project and/or develops one or all of the competences.

The following table 1 shows a list by way of example of the various competences which can be developed by each participant together with the forms with which said competences are assessed (the forms are called the same as the phases in which they are carried out, but are in brackets: for example, form [A] assesses the competences developed in phase A).

TABLE 1
Competences and forms with which they are assessed

| | | | Forms | | | | | | | | | | | | | | |
|---|---|---|---|---|---|---|---|---|---|---|---|---|---|---|---|---|---|
| Competences | | | [A] | [B] | [C] | [D] | [E] | [N] | [BC] | [TW] | [A*] | [B*] | [C*] | [D*] | [E*] | [DS] | [DC] |
| Technical | 1 | Project requirements | X | | | | | X | | | X | | | | X | X | X |
| Competences | | & objectives | | | | | | | | | | | | | | | |
| | 2 | Risk& opportunity | | X | | X | | | | | | X | | X | | | |
| | 3 | Teamwork | | | X | X | X | | | X | | | X | X | X | | |
| | 4 | Scope & deliverables | X | | | X | | | | | X | | | X | | X | X |
| | 5 | Time & Project phases | X | X | | X | | | | | X | X | | X | | | |
| | 6 | Resources | | X | | X | | | | X | | X | | X | | X | |
| | 7 | Cost and finance | | X | | | | | | | | X | | | | | |
| | 8 | Procurement and | | X | | X | X | X | | | | X | | X | X | | |
| | | contract | | | | | | | | | | | | | | | |
| | 9 | Changes | | | X | | | X | | | | | X | | | X | |
| | 10 | Control and reports | X | X | X | X | X | | | X | X | X | X | X | X | X | |
| | 11 | Information and | | X | | | | | | | | X | | | | | X |
| | | documentation | | | | | | | | | | | | | | | |
| | 12 | Communication | | X | X | | X | | | X | | X | X | | X | X | |
| Behavioral | 13 | Negotiation | | | | | | X | X | | | | | | | | |
| Competences | 14 | Results orientation | | | | | | | X | | | | | | | | |
| | 15 | Engagement | | | | | | | X | | | | | | | | |
| | | & motivation | | | | | | | | | | | | | | | |
| | 16 | Leadership | | | | | | | X | | | | | | | | |

*: form filled in only by the auditor

Form [BC] is used for assessing the behavior competences throughout the entire simulation. Form [TW] is used for assessing the technical competences related with the teamwork developed throughout the entire simulation. Form [N] is used for assessing negotiation competences. Form [DS] is used for the self-assessment of the author of a deliverable product him/herself, while form [DC] is used for assessing the author of a deliverable product by whoever receives said deliverable product. According to the ICB-IPMA Competence Baseline (Version 3.0) of the International Project Management Association (IPMA), the deliverables of a project, program or portfolio are tangible or intangible assets created by the project, program or portfolio for the client. The deliverables are depicted by plans, diagrams, descriptions, models, prototypes, systems and products of different classes. The deliverables are not only the product sold or the service put into use after closing a project, but also the operating processes, the organizational changes and the changes in human resources necessary so that a successful organization can operate.

According to an embodiment of the competence assessment method, each assessed participant is assessed by all the other participants of the project interacting with the participant in question for a given competence. FIG. 3 thus schematically shows the assessment of a subproject manager by all the participants of the project interacting with the subproject manager by means of forms such as those described hereinabove. More specifically, the subproject manager is assessed by:
the subproject manager (PM) him/herself, performing a self-assessment of his/her competences (forms [A], [B], [C], [D], [E]);
at least one auditor (AD) (forms [A*], [B*], [C*], [D*], [E*]);
the main project manager (PMm), serving as the client with respect to the subproject (forms [A], [B], [C], [D], [E], [TW], [BC], [N]);
the remaining subproject managers (PM) in the subproject management team (forms [TW], [BC]);
the members of the subproject work team (TM) (forms [TW], [BC], [N]); and
the subcontract project manager (PMsc) (forms [TW], [BC], [N]).

Accordingly, as shown in FIG. 3, the subproject manager is thus assessed by all the participants of the project interacting with said subproject manager by means of a 360-degree feedback.

Each of the competences described hereinabove is assessed by means of the aforementioned forms, by means of at least one piece of evidence clearly having those criteria determining the maximum degree of performance specified therein. In an embodiment of the invention for example, technical competence 5 (Time & Project phases) is assessed by means of 11 pieces of evidence, said pieces of evidence being produced throughout three phases (4 pieces of evidence in phase A, 6 pieces of evidence in phase B and 1 piece of evidence in phase D). Thus, for example, piece of evidence 6 of competence 5 in phase B, assessed by the auditor (AD) in form [B*], can be: “The project work plan as well as the project baseline have been defined in the project management software. Below is a list of example criteria that determine maximum performance:

[a] The task duration, start-end dates and priorities are observed.

[b] The work plan tasks are correctly related with the phases of the project.

[c] There are pieces of evidence in the records that the work plan has been presented and agreed on by the project management team.

[d] All the agreed on deliverables that are related with their corresponding tasks.

[e] There is a project baseline.

In each assessment form, the assessor will introduce his/her opinion on the achievement level attained by the assessed participant in each piece of evidence given, using a Likert scale (of 1 to 5), for example, in which:
5 means that the assessor completely agrees that the assessed participant complies with all the aspects considered in the piece of evidence;
4 means that the assessor agrees;
3 means that the assessor neither agrees nor disagrees;
2 means that the assessor disagrees;
1 means that the assessor completely disagrees.

Other assessment scales may be used as well. Each piece of evidence of each competence developed by an assessed participant thus receives a numerical assessment by each project participant interacting with said assessed participant with respect to that competence.

The method according to the present invention therefore comprises applying, in a simulation environment, the numerical data obtained by means of the assessment described above in the following formula:

$${Cmp}_{i} = \frac{1}{{\sum }_{x = 1}^{l} {W}_{x}} \cdot \frac{1}{{\sum }_{r = 1}^{m} {k}_{r}} \cdot \frac{1}{{\sum }_{j = 1}^{n} {p}_{j}} \cdot {\sum }_{x = 1}^{l} {\sum }_{r = 1}^{m} {\sum }_{j = 1}^{n} {W}_{x} \cdot {k}_{r} \cdot \frac{{p}_{j}}{{q}_{r}} {\sum }_{s = 1}^{{q}_{r}} E {v}_{j , s}$$

wherein
Cmpᵢ is the numerical assessment of the achievement level of the competence i;
Wₓ is the weight of the phase x in which the competence is assessed;
x is the phase in which the competence is assessed;
l is the total number of phases in which the competence is assessed;
kᵣ is the weight of the opinions of each assessor figure;
r is the assessor figure carrying out a specific function;
m is the total number of assessor figures;
pⱼ is the weight of each piece of evidence of a competence;
j is a piece of evidence;
n is the total number of pieces of evidence of a competence;
qᵣ is the total number of assessors with the same function;
Ev_{j,s}, is the numerical assessment of the piece of evidence j obtained from each assessor s with the same function; and
s is the assessor with a given function performing the assessment.

A numerical assessment value of each competence developed by each project participant is thus obtained.

Variables Wₓ, kᵣ or pⱼ can take different values for each phase, opinion or piece of evidence.

As mentioned above, it is evident that the organizational structure shown in FIG. 2 can also be applied without any modification to other levels within a more complex structure, such as for example a structure formed by: program, project and subcontract project or a structure formed by a project portfolio, project and subcontract project. Assessing each participant in each level by all the other participants interacting with the participant in question by means of a of 360-degree feedback is thus allowed according to FIG. 3. The numerical values obtained are used in the numerical assessment of the competence achievement level according to the formula of the present invention.

A specific non-limiting example of numerical application of the competence assessment method according to an embodiment of the present invention is shown below. The numerical assessment of competence 15 (engagement and motivation) developed by a subproject manager is shown by way of example. Said competence is assessed only by means of form [BC] (see Table 1 above) by means of four pieces of evidence. In the present example, the assessment of this competence at the end of phase E of the subproject is all that will be taken into account. The following Table 2 shows the pertinent data in this example:

TABLE 2
Assessment of competence 15 of a subproject manager

| | | | PM | AD | PMm | PMsc | TM | | | Other PM | | |
|---|---|---|---|---|---|---|---|---|---|---|---|---|
| | | | k₁ | k₂ | k₃ | k₄ | k₅ | | | k₆ | | |
| | | | 1 | 5 | 3 | 2 | 2 | | | 3 | | |
| | | | — | — | S₁ | S₁ | S₁ | S₂ | S₃ | S₁ | S₂ | S₃ |
| As₁ | p₁ | 5 | — | — | 5 | 1 | 2 | 5 | 2 | 1 | 2 | 5 |
| As₂ | P₂ | 5 | — | — | 3 | 4 | 5 | 5 | 3 | 2 | 2 | 2 |
| As₃ | p₃ | 3 | — | — | 3 | 5 | 3 | 2 | 5 | 3 | 5 | 4 |
| As₄ | p₄ | 4 | — | — | 4 | 4 | 2 | 2 | 4 | 5 | 4 | 4 |

It is seen that in this specific case, the total number of phases in which the competence is assessed is 1 (phase E), in this case phase E having a weight (W_{E}) of 3. The weight of the assessor figures (k₁₋₆) is shown in Table 2 above. The total number of assessor figures (m) in this case is 4, since neither the subproject manager him/herself nor the auditor assess competence 15. The weight of each of the pieces of evidence (p₁₋₄) for competence 15 is also provided in Table 2 above.

It must be observed that in this case there is only one assessor whose function (assessor figure) is that of main project manager; just as there is only one assessor whose function is that of subcontract project manager. However, there are three assessors whose function is that of subproject team member. There are also three assessors whose function is that of subproject manager, different from the subproject manager being assessed. Therefore in the two first cases, variable qᵣ is equal to 1, while in the two last cases variable qᵣ in the above formula is equal to 3.

When introducing the numerical values depicted in Table 2 above into the formula of the present invention:

$${Cmp}_{i} = \frac{1}{{\sum }_{x = 1}^{l} {W}_{x}} \cdot \frac{1}{{\sum }_{r = 1}^{m} {k}_{r}} \cdot \frac{1}{{\sum }_{j = 1}^{n} {p}_{j}} \cdot {\sum }_{x = 1}^{l} {\sum }_{r = 1}^{m} {\sum }_{j = 1}^{n} {W}_{x} \cdot {k}_{r} \cdot \frac{{p}_{j}}{{q}_{r}} {\sum }_{s = 1}^{{q}_{r}} E {v}_{j , s}$$

the following result is obtained:

Cmp₁₅=3.41

In other words, the subproject manager assessed has obtained a numerical value for competence 15 of 3.41, with respect to a maximum numerical value of 5 which can be assigned.

As can be seen, the method according to the present invention allows assessing project management competences through putting said competences into practice in a simulation environment. The system is characterized in that it allows rating individual competences through a set of performance indicators. The indicators are obtained both from pieces of analytical evidence and from the opinions of other participants in the simulation in relation to the abilities demonstrated by the candidate through his/her specific actions. The system further allows obtaining information about the level of competences demonstrated not through measuring individual knowledge, but from the result of use in the simulation environment. There is no dependency relationship between the type of simulation which is developed (for example, for one type of project) and the competences which are measured are rated through indicators which are produced at different times of the simulation life cycle, paying attention to the roles of each participant, to the purpose of the participation, to the project structure itself, to the specific product which is being created, etc. The competence assessment system is independent of the purpose of the developed project; it also allows developing all or part of the defined competences as all the phases of the project or some in particular.

According to an additional embodiment of the present invention, the method comprises:
firstly, obtaining numerical assessments of the achievement of each competence by each participant in the project by means of applying the above formula as described hereinabove;
and then applying data mining techniques for identifying combinations of competences of assessed participants determining the final quality of the project.

In other words, the method of the present invention can be used, resorting to historical data of previous projects, for determining the competences having more influence on the final result of a project, such that taking preventative measures for optimizing said final result of the project is allowed. Specifically, according to an additional embodiment of the present invention, the method further comprises:
predicting the final quality of a project depending on said data mining step; and
applying corrective actions depending on the quality predicted in the preceding step.

According to another embodiment of the present invention, the method further comprises determining, after the data mining step described above, an optimized function for determining a final numerical qualification of an assessed participant. Said step further includes varying the weight of the competences having the greatest influence on the final quality of the project for optimizing the obtained result.

According to an embodiment of the competence assessment method of the present invention, data mining techniques can be applied for identifying the competences which best define the performance of the assessed person, in this example the PM.

The Auditor assesses the projects in which each participant has participated, qualifying them as, for example, Good, Fair and Poor (other levels can be determined). The quality of a project is determined in terms of degree of compliance with the agreements reached with the client: quality of the deliverables, compliance with the deadline and cost, level of satisfaction, etc. The numerical qualifications of the level of development of each of the competences in each project, obtained by the assessor figures, are known for each participant. Therefore, when using data mining techniques, for example, “Supervised Classification” by means of “Discriminant Analysis”, it allows obtaining a discriminant function, Q, which allows:
Identifying those competences (or combinations thereof) together with their levels of achievement, relating to the performance of a PM, which have always led the project to a specific quality (Good, Poor or Fair), i.e., classifying the projects depending on specific combinations of competences.
Predicting the final quality of a project, at a time of its execution, depending on the achievement level of these competences.
Defining an optimized function (optimized F) using the above information which allows determining the overall numerical qualification of the PM (K[PM]), for example, increasing the specific weight of those competences having a greater influence at the time of obtaining “Good” projects. For example:
   Type A competences: with a high level of development (>4 out of 5), they lead the project to success, i.e., “Good” project, therefore, these competences must have a higher weight.
   Type B competences: with a medium level of development (2-3 out of 5) they indicate a “Fair” project, therefore, these competences must be have an intermediate weight.
   Type C competences: with a low level of development (>2 out of 5), they indicate a “Poor” project, therefore, these competences must be have a low weight.

Therefore, by having numerical values for all the competences developed and the optimized function (optimized F) it is possible to obtain the numerical assessment of the achievement level of all the competences developed by the PM according to the formula:

K[PM]=optimized F(Cmpᵢ)

Evidently, although the method of the present invention has been described with reference to specific embodiments thereof, persons skilled in the art understand that modifications and variations can be made without departing the scope of protection of the attached claims. For example, according to specific embodiments of the invention, each assessed participant will only be able to be assessed by the Auditor figure, specifically dedicated to this function.

As described hereinabove, a second aspect of the present invention discloses a competence assessment system for assessing the competences of participants in a project, or in a set of related projects or a set of projects not related to one another, which allows implementing the competence assessment method according to the first aspect of the invention described hereinabove. It specifically relates to a computer system with multilayer architecture comprising at least three layers:
a presentation layer providing the user interface
an application layer implementing the functionality of the competence assessment method described hereinabove; and
a data layer providing the management and storage of the data related with the method.

More preferably, the competence assessment system has at least three levels. A first level is a client level, comprising the user interface installed in a user device with internet access. The second level is an intermediate level comprising a presentation layer and an application layer. This intermediate level comprises a web server responsible for constructing the user interface (presentation layer) as well as an application server responsible for receiving events from the users, executing them in the specific tools of the competence assessment method and replying to them (application layer). Said application server also manages communication with the data layer. Finally, the third level is a data level, in which the data layer is located, which manages and stores data generated by the application layer.

According to an embodiment of the present invention, the competence assessment system comprises:
a project portfolio management software;
a collection software for collecting numerical assessments through forms for assessing various competences;
an integration software for supervising the operation of the simulation for each participant; and, optionally,
a forensic analysis software providing traceability to the ratings performed.

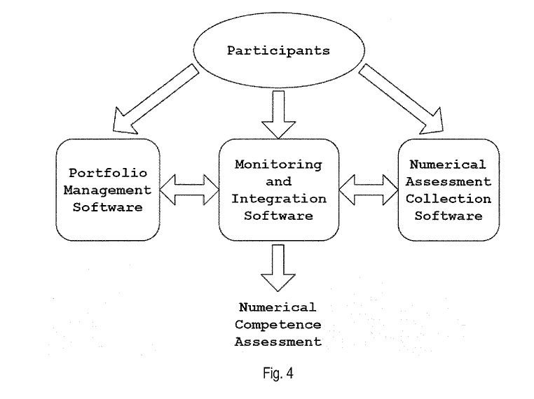

In the above described embodiments, the term simulation environment is the name given to a set of information systems (hardware and software) interconnected through a TCP/IP communications network which facilitates the competence assessment in project management. As seen in FIG. 4, such an environment is based on a computer system that supports a software tool for project portfolio management, a computer system that supports a software tool for collecting numerical assessments through forms, and another computer system that supports an integration software tool to monitor the operation of the simulation for each participant. In some embodiments, the above described tools may be hosted in one or more devices.

The software tools encompassed in this simulation environment are implemented in a computer system with a multi-tier architecture (“n-tier”) including at least
A presentation tier that is responsible for the user interface, displaying information and interacting with the application tier.
An application tier that implements the competence assessment functionality and is responsible to collect input from users, to perform the corresponding application tasks and to return appropriate results through the presentation layer.
A data tier that delivers the data necessary for the application to function. It is responsible to store and retrieve information.

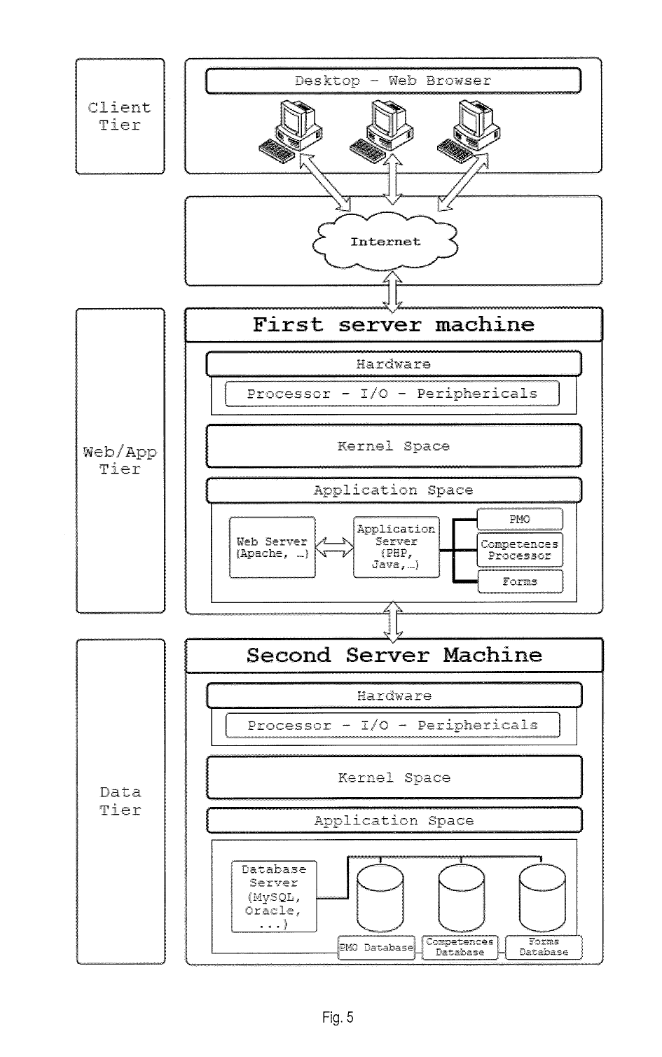

As seen in FIG. 5, the competence assessment system may exist as a three-tier application architecture (client, web/application server, and database tiers) as follows:
1. The client tier is a level that manages user interactions with the applications by means of a web browser.
2. The web/app tier is an application processing level. This layer contains, at least, a web server (for example, Apache), which is responsible for generating the user interface, and an application server (for example, PHP or JAVA), which is responsible for receiving user events, running them on the specific tools of the method of competence assessment and responding to them. This application server also manages communication with the data tier.
3. The data tier manages and stores data generated by the application layer. This data tier contains, at least, a database server (for example, Oracle or My SQL).

As seen in FIG. 5, the intermediate level (web/app tier) and the data tier are physically implemented in independent servers (First Server Machine and Second Server Machine). In both cases, the operating system is structured in layers. The kernel space is the interface between the hardware (processor, memory, input/output devices, etc.) and the software (programs executed in the application space).

One skilled in the art would know that each of client tier, web/app tier and data tier includes one or more processors, and may include one or more displays, data input units and various input and output connections.

The system of the present invention preferably comprises at least the functions of proprietor, auditor and assessed participant (although, as seen hereinabove, it can comprise more functions). However, it must be understood that one and the same person can perform various functions within the competence assessment system of the present invention. For example, the functions of proprietor and auditor can be performed by one and the same person.

Furthermore, the system allows the remote interaction of participants, with different locations, time zones, cultural bases, etc., so it is not restricted to a single specific time or physical space.

The competence assessment method and system of the present invention are widely applicable in any field of the industry since they allow maximizing the final result of any project, optimizing the use of the available resources assigning to specific managers the competences in which they obtain higher numerical competence assessment scores.

However, the method and system of the present invention also find other types of applications within the art which are equally interesting. For example, they can be used as professional project manager certification tool. They are also are useful as an instrument to improve the recruitment of staff for project management.

1. A competence assessment method for assessing the competences of a participant in a project, the project comprising a phase, a competence of an assessed participant intervening in the phase of the project, said competence being assessed by at least one assessor by a piece of evidence, the method comprising:
determining, by a simulation device, a numerical assessment of an achievement level of the competence i depending on given variables:
Cmpᵢ=fᵢ(Ev_{j,s},Wₓ,kᵣ,pⱼ)
wherein:
Cmpᵢ is the numerical assessment of the achievement level of the competence i;
Wₓ is a weight of a phase x in which the competence i is assessed;
x is a phase in which the competence i is assessed;
kᵣ is a weight of an opinion of the assessor;
r is the assessor carrying out a specific function;
pⱼ is a weight of a piece of evidence of competence i;
j is the piece of evidence;
Ev_{j,s}, is a numerical assessment of the piece of evidence j obtained from an assessor s;
s is the assessor with a given function performing the assessment.

2. The competence assessment method according to claim 1, characterized in that formula fᵢ is:
$${Cmp}_{i} = \frac{1}{{\sum }_{x = 1}^{l} {W}_{x}} \cdot \frac{1}{{\sum }_{r = 1}^{m} {k}_{r}} \cdot \frac{1}{{\sum }_{j = 1}^{n} {p}_{j}} \cdot {\sum }_{x = 1}^{l} {\sum }_{r = 1}^{m} {\sum }_{j = 1}^{n} {W}_{x} \cdot {k}_{r} \cdot \frac{{p}_{j}}{{q}_{r}} {\sum }_{s = 1}^{{q}_{r}} E {v}_{j , s}$$
wherein
l is a total number of phases in which the competence is assessed;
m is a total number of assessor figures;
n is a total number of pieces of evidence of a competence; and
qᵣ is a total number of assessors with the same function.

3. The method according to claim 1, wherein each assessor introduces a corresponding numerical assessment of each piece of evidence of the assessed participant with a Likert type qualitative scale.

4. The competence assessment method according claim 1, wherein the assessed participant is selected from a project manager, a subproject manager and a subcontract manager.

5. The competence assessment method according to claim 1, wherein each assessed participant is assessed by auditors.

6. The competence assessment method according to claim 1, wherein each assessed participant is assessed by all other participants of the project interacting with him/her for a given competence.

7. The competence assessment method according to claim 6, wherein each assessed participant is additionally assessed by him/herself.

8. The competence assessment method according to claim 1, wherein the project comprises at least one subproject, the participants of said at least one subproject being assessed by the competence assessment method of claim 1.

9. The competence assessment method according to claim 1, wherein the project forms part of a high-level structure including at least one of: a program, another project and a subcontract project, the participants being assessed by the competence assessment method according to claim 1.

10. The competence assessment method according to claim 1, wherein the project forms part of a high-level structure formed by, another project and a subcontract project, the participants being assessed by the competence assessment method according to claim 1.

11. The competence assessment method according to claim 1, further comprising:
obtaining numerical assessments of the achievement of each competence by multiple participants by applying the formula according to claim 1; and
applying data mining techniques for identifying combinations of competences of assessed participants in order to determine a final quality of the project.

12. The competence assessment method according to claim 11, further comprising:
predicting the final quality of the project depending on the data mining step; and
applying corrective actions depending on the final quality predicted in the predicting step.

13. The competence assessment method according to claim 11, further comprising:
determining, after the step of applying data mining techniques, an optimized function for determining a final numerical qualification of an assessed participant by varying weights of competences having a greater influence on the final quality of the project.

14. A competence assessment system for assessing the competences of participants in a project, comprising:
a computer system with multilayer architecture including:
a presentation layer configured to provide a user interface
an application layer configured to implement the competence assessment method according to claim 1; and
a data layer configured to manage and store data related to the method.

15. The competence assessment system according to claim 14, comprising:
at least three levels, the at least three levels including:
a client level comprising the user interface, the user interface installed in a user device equipped with an Internet access;
an intermediate level installed in a computer device connected to the user device via the Internet access, the intermediate device comprising a presentation layer and an application layer; and
a data level including the data layer and installed in a storage device.

16. The competence assessment system according to claim 15, wherein the user interface is an Internet browser.

17. The competence assessment system according to claim 14, wherein the computer system is configured to operate:
management software for managing a set of projects;
collection software for collecting numerical assessments through forms for assessing various competences; and
integration software for supervising the operation of the simulation for each participant.

18. The competence assessment system according to claim 17, wherein the computer system is configured to operate:
forensic analysis software providing traceability to the ratings performed.
